(19) United States
(12) Patent Application Publication
(10) Pub. No.: US 2004/0018059 A1
(43) Pub. Date: Jan. 29, 2004

(54) Distance retainer for media pipes that are to be guided through protective pipes

(76) Inventors: Bernd Skerra, Mossingen (DE); Uli Lutz, Ebersbach (DE)

Correspondence Address: Felix J D'Ambrosio, Jones Tullar & Cooper, Eads Station, P O Box 2266, Arlington, VA, 22202, US

(21) Appl. No.: 10/257,938

(22) PCT Filed: Mar. 8, 2001
(86) PCT No.: PCT/EP01/02601

(30) Foreign Application Priority Data
Apr. 19, 2000 (DE) 200 07 174.2

(51) Int. Cl. F16L 55/18; F16L 1/06

(52) U.S. Cl. 405/184.4; 405/184.1

(57) ABSTRACT

A distance retainer for media pipes to be guided through protective pipes is provided with a ring body consisting of several ring segments which are in turn provided with radially projecting, axially oriented sliding runners and which are manufactured from plastic. Connecting elements which engage with each other are provided on the ends of the ring segments that face towards each other. The axial recesses of these connecting elements that lie axially adjacent to each other are penetrated by an axial connecting mechanism. The invention provides that in order to be able to adapt the diameter to the particular media pipes within greater diameter ranges and therefore more simply, the connecting elements that engage with each other lie on top of each other in a radial direction and one connecting element is provided with two or more recesses which lie behind each other, a distance apart, in the peripheral direction.

### SPECIFICATION

The present invention relates to a distance retainer for media pipes to be guided through protective pipes, as generically defined by the preamble to claim 1.

In one such distance retainer, known from German Utility Model DE-U 93 07 170, the connecting elements of what there is a single ring segment are formed by eyelets formed onto its ends and engaging next to one another, through whose bore recesses a pin, as a connecting mechanism, is thrust axially.

A distance retainer of this kind must be adapted relatively precisely to the diameter of the media pipe, since the distance retainer, in the state where it is connected on its ends, has a defined inside diameter that should as precisely as possible match the outside diameter of the media pipe it is intended to surround. This means that for media pipes of different diameters or diameter regions, one distance retainer of appropriate size must be kept on hand for each different media pipe.

For diameter adaptation within relatively narrow limits, a distance retainer is known from German Utility Model DE-U 296 00 375, whose ring segments are provided with radially protruding connecting flanges, and adjacent flanges are connected to an elastic clamping ring. It has been demonstrated that there are still overly narrow limits to the diameter adaptation of such distance retainers to diameter ranges of the media pipes.

It is therefore the object of the present invention to create a distance retainer for media pipes to be guided through protective pipes, of the type defined at the outset, with which a diameter adaptation to the applicable media pipes in larger diameter ranges and thus with fewer problems is made possible.

To attain this object, in a distance retainer for media pipes to be guided through protective pipes of the type defined, the characteristics recited in claim 1 are provided.

By the provisions of the invention, because of the spaced-apart recesses for the connecting mechanism, an adaptation that covers wide diameter ranges of a distance retainer to various media pipe diameters is made possible. Large diameter ranges are adequately in particular whenever the distance retainer is provided with two or more ring segments, since each connecting region between two ring segments can be varied in a suitable way.

An axial, that is, lateral guidance of the two connecting elements with one another is obtained whenever the characteristics of claim 2 are provided.

With the characteristics of claim 3, a simple parallel displacement counter to one another of the two connecting elements is assured.

Advantageous structural features of the two connecting elements are obtained by the characteristics of one or more of claims 4-6.

A simple first fixation in the radial direction is achieved whenever the characteristics of claim 7 are provided. A further advantage is that the connecting mechanism can be introduced in a simple way into the recesses that are thus located in a line. If the one connecting element is provided with parallel fingers, then expediently the characteristics of claim 8 are provided.

Another advantageous provision for simple mounting or introduction of the connecting mechanism through the two connecting elements is obtained whenever the characteristics of claim 9 are provided, since in this way a circumferential detent lock is achieved in advance.

With the characteristics of claim 10 and/or claim 11, an economical, easily manipulated connecting mechanism is achieved. In the one case, it suffices simply to push the connecting mechanism through, while in the other case an additional securing is attained by connecting the ends of the tightening strap.

Further details of the invention can be learned from the ensuing description, in which the invention is described and explained in further detail in terms of the exemplary embodiment shown in the drawing. Shown are:

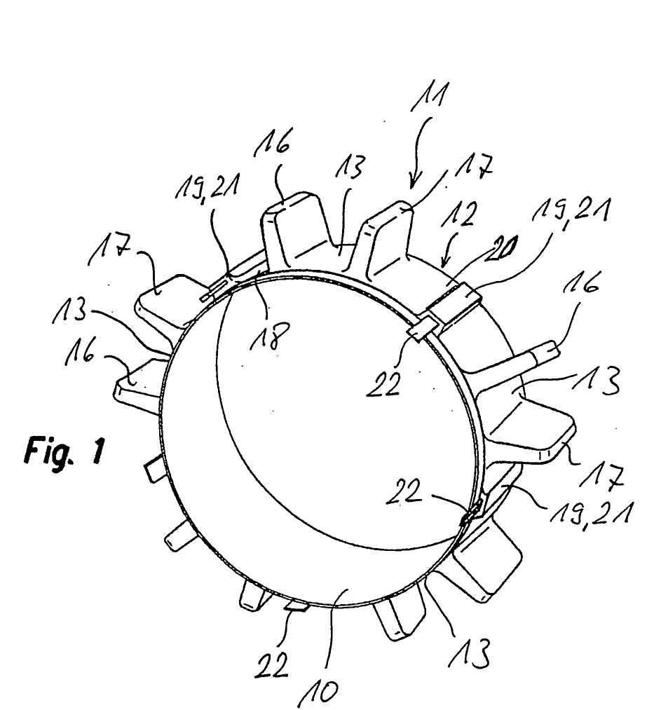

FIG. 1, in a schematic, perspective view, a distance retainer, tightened around a media pipe and constructed of a plurality of ring segments, in a preferred exemplary embodiment of the present invention;

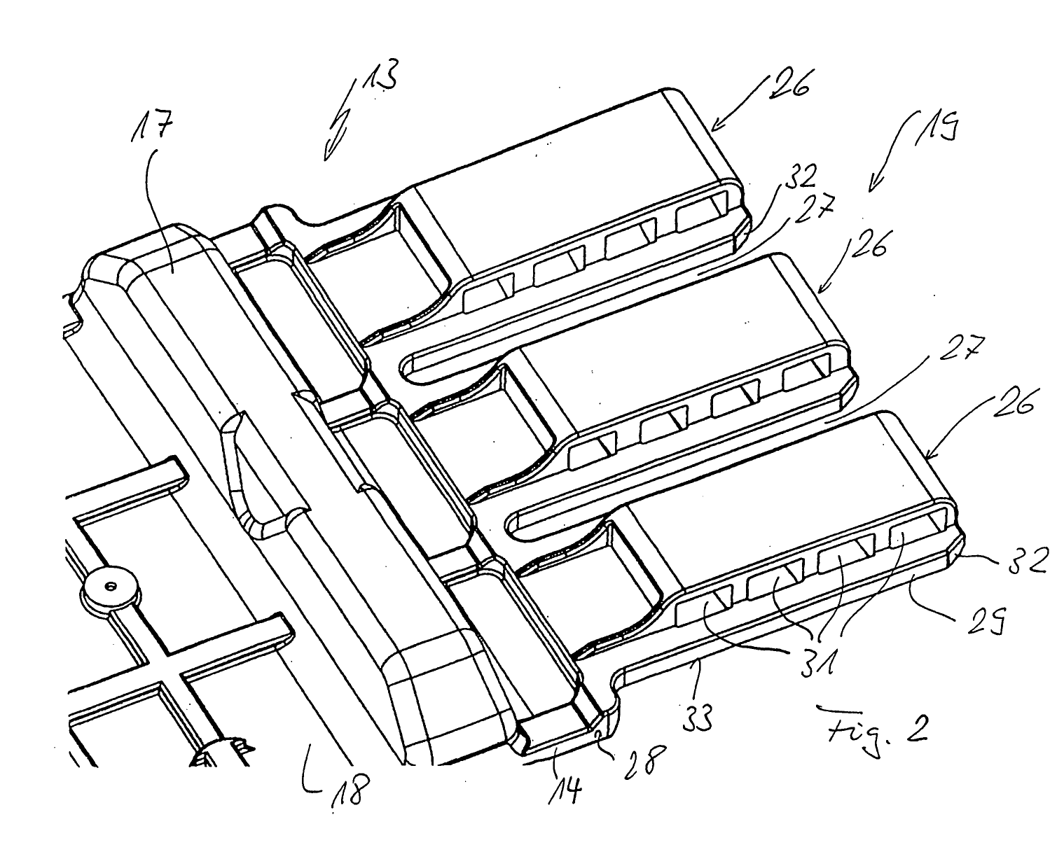

FIG. 2, in an enlarged perspective view, the one connecting element of a ring segment;

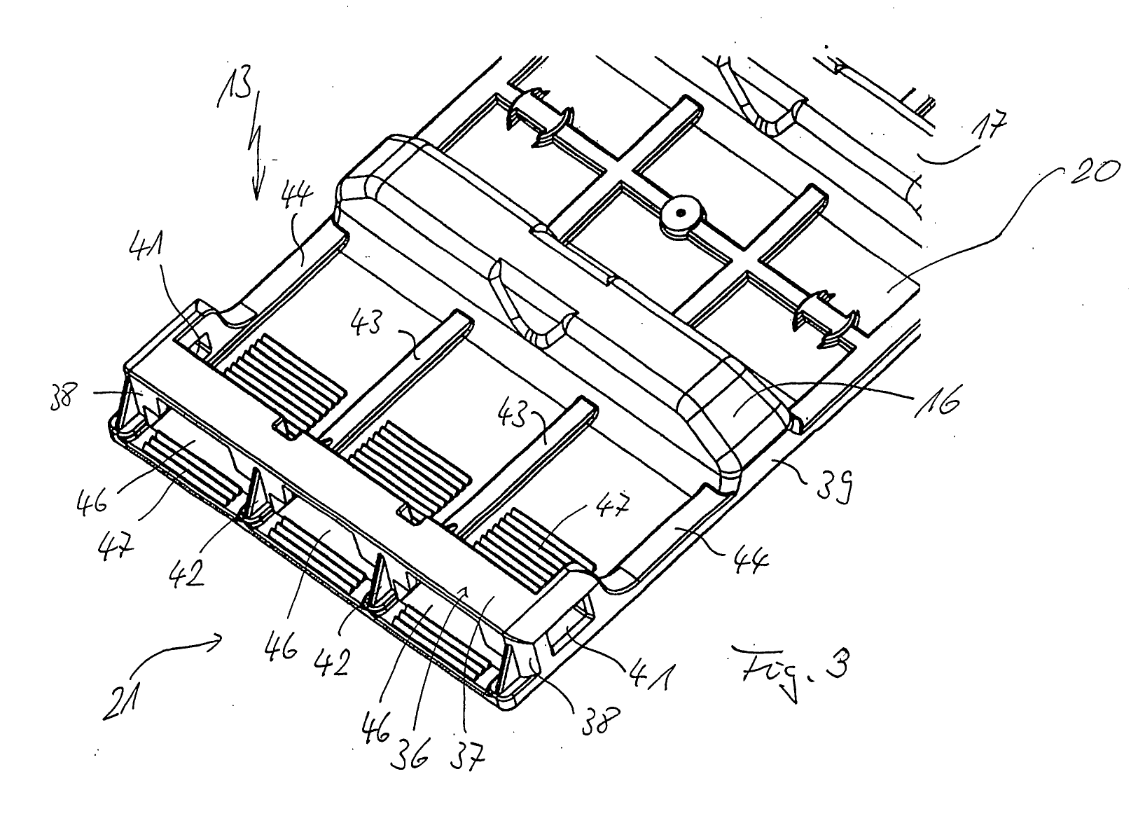

FIG. 3, in an enlarged perspective view, the other connecting element of the same or an adjacent ring segment; and

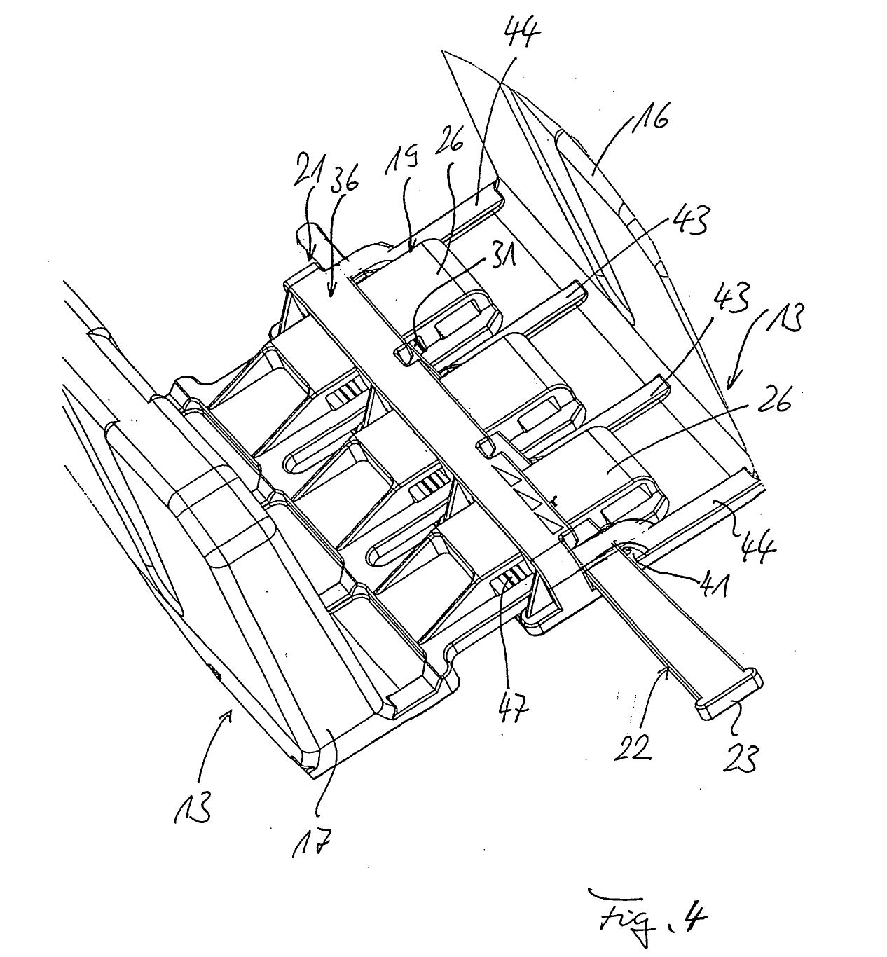

FIG. 4, in an enlarged perspective view, the connection of the one connecting element of one ring segment to the other connecting element of an adjacent ring segment.

In the exemplary embodiment of the present invention shown in the drawing, a media pipe 10, which is meant to be laid through a protective pipe, not shown, is occupied on the outer circumference with a distance retainer 11 at intervals. The distance retainers 11, clamped on in a nonshifting way, serve to introduce the media pipe 10 into a protective pipe, on the one hand for the sake of maintaining the spacing between the inner media pipe 10 and the outer protective pipe, and on the other serve as slide bodies for reducing the friction upon insertion. To that end, the distance retainer 11 is made for instance from plastic that is capable of sliding well.

The distance retainer 11 has a ring body 12 comprising a plurality of identically embodied ring segments 13. It is understood that the ring body 12 can also comprise only one, or more or fewer than the ring segments shown here, depending on the outer diameter of the media pipe 10. Each ring segment 13 on its outer circumference has radially projecting protrusions 16, 17, which here are parallel, and which extend in the axial direction of the ring body 12 and act as sliding runners. It is understood that the ring segment 13 may instead have only one sliding runner or more than two sliding runners 16, 17.

The ring segment 13, which is symmetrical with respect to its longitudinal center axis, has one connecting element 19 and 21 on each end 18 and 20, respectively; the one connecting element 19 is provided on one end 18, and the other connecting element 21 is provided on the other end 20, or in the case of a ring segment of plastic, the connecting elements are formed on. The two connecting elements 19 and 21 are of such a nature that they fit inside one another and can be joined to one another for fixation in the circumferential direction by a connecting mechanism 22. In the exemplary embodiment shown, the ring segments 13 are each embodied of equal length; it is understood that for a media pipe 10 it is also possible for ring segments 13 of different lengths to be used, so that they each span different-sized circular arcs.

The one connecting element 19 on one end 18 of the ring segment 13 is formed by three parallel boxlike identical fingers 26. Between the parallel fingers 26, slots 27 are provided; the outer edges of the fingers 26 are offset parallel inward from the outer edge 28 of the ring segment 13. The bottom 29 of the one connecting element 19 is offset radially outward by a dimension that is approximately equivalent to the thickness of the base plate 14 of the ring segment 13. The fingers 26 have a plurality of axially extending recesses 31, disposed at distances from one another in the circumferential direction, which in the exemplary embodiment have a rectangular cross section. In the axial direction, the various recesses 31 of the three parallel fingers 26 are aligned with one another. The free ends of the fingers 26, or of their bottom regions 29 are provided with insertion chamfers 32. The underside 33 of the bottom 29 of the fingers 26 is provided, in a manner not shown, with detent elements, such as axially extending fluting.

The other connecting element 21 on the other end 20 of the ring segment 13 has a bridge element 36, which has a bridge strip 37 that extends parallel to and spaced apart from the bottom 39, and has supports 38 on both ends, which are wider in the circumferential direction than the bridge strip 37. In a region on the far side of the bridge strip 37 (as viewed from the free end), the supports 38 each have a recess 41, which in the exemplary embodiment has a rectangular cross section. The recesses 41 of this other connecting element 21 have the same cross section as the recesses 31 of the one connecting element 19. The bridge strip 37 is braced on the bottom 39 by means of two intermediate bearings 42, and the intermediate bearings 42 stand on guide strips 43 that extend parallel from the free end of the other connecting element 21 on its bottom 39, across the length thereof. Parallel to these middle guide strips 43, outer guide strips 44 are present, that extend in the extension of the supports 38. The top side of the bottom 39 is likewise provided with detent elements, such as axially extending fluting 47. These detent elements 47 are provided, viewed in the circumferential direction, over only a portion of the other connecting element 21.

For mounting a distance retainer 11, or its ring body 12, around a media pipe of a certain diameter, a plurality of ring segments 13 are joined together by slipping the two connecting elements 19 and 21 into one another (FIG. 4). When the one connecting element 19 is inserted into the other connecting element 21, the fingers 26 are brought through the guide openings 46 of the bridge element 36 of the other connecting element 21, and the underside 31 of the one connecting element 19 slides on the top side 40 of the other connecting element 21, and the fingers 26 are guided in the axial direction between the middle guide strips 43 and the outer guide strips 44. The detent elements 47 on the underside 43 of the bottom 29 and on the top side 40 of the bottom 39 prevent the two connecting elements 19 and 21 from sliding apart unintentionally. A taut, or in other words essentially nonshifting placement of the distance retainer 11 around the media pipe 10 and the putting together of the two connecting elements 19 and 21 by hand can be done by grasping the sliding runners 16, 17 of adjacent ring segments 13. Slipping the connecting elements 19 and 21 into one another is done to an extent such that a group of aligned recesses 31 of the one connecting element 19 comes to be approximately in alignment with the outside recesses 41 of the other connecting element 21. The connecting mechanism 22 is inserted in the axial direction into the then-aligned recesses 31 and 41 of the two connecting elements 19 and 21.

In the exemplary embodiment shown, the connecting mechanism 22 is a plastic strap provided with a wider handle end 23, which strap can extend in slightly wedgelike fashion toward its end remote from the handle end 23. It is understood that a typical plastic tightening strap, whose two ends can be joined together by means of detentlike looping, can also be used as the connecting mechanism 22.

Because there is a plurality of pairs of recesses, disposed in the circumferential direction, of the fingers 26, particularly in the case of ring bodies 12 that are put together from a plurality of ring segments 13, an adaptation to wide diameter ranges of the media pipes 10 is possible. It is also possible for the media pipe 10 to be surrounded in slip-proof fashion by readjusting the individual connections among the plurality of ring segments 13.

1. A distance retainer (11) for media pipes (10) to be guided through protective pipes, having a ring body (12) consisting of one or more ring segments (13) that are provided with radially protruding, axially oriented sliding runners (16, 17) and are made from plastic, wherein connecting elements (19, 21) meshing with one another are provided on the ends (18, 20), oriented toward one another, of the ring segment or segments (13), the axial recesses (31, 41) of which connecting elements are located axially side by side and are penetrated by an axial connecting mechanism (22), characterized in that the meshing connecting elements (19, 21) rest on one another in the radial direction, and that the one connecting element (19) is provided with two or more recesses (31) located at a distance from one another in the circumferential direction.

2. The distance retainer of claim 1, characterized in that the one connecting element (19) is axially fixed between two radial protrusions (44), on the outer periphery and having recesses (41), of the other connecting element (21).

3. The distance retainer of claim 1 or 2, characterized in that the one connecting element (19), on its formed-on end (19), is radially offset-bent by the thickness of the bottom (39) of the other connecting element (21).

4. The distance retainer of at least one of claims 13, characterized in that the one connecting element (19) is provided with two or more fingers (26), having the recesses (31) and disposed axially at a distance from one another.

5. The distance retainer of claim 4, characterized in that the fingers (26) have two or more recesses (31) located one after the other in the circumferential direction.

6. The distance retainer of claim 4 or 5, characterized in that the other connecting element (21) is provided with guide strips that mesh between or beside the fingers (26) of the one connecting element (19).

7. The distance retainer of at least one of the foregoing claims, characterized in that the other connecting element (21), on its free end, has an encompassing guide receptacle (46) for the one connecting element (19).

8. The distance retainer of claims 4 and 7, characterized in that the guide receptacle (46) is subdivided into segments located axially side by side.

9. The distance retainer of at least one of the foregoing claims, characterized in that the underside (33) of the one connecting element (19) and the top side (40) of the other connecting element (21) are provided with detent elements (47) extending transversely to the insertion direction.

10. The distance retainer of at least one of the foregoing claims, characterized in that the connecting mechanism (22) is a plastic strap.

11. The distance retainer of claim 10, characterized in that the plastic strap extends conically.

12. The distance retainer of claim 10, characterized in that the connecting mechanism is a plastic tightening strap.
